(19) United States
(12) Patent Application Publication
(10) Pub. No.: US 2026/0025556 A1
(43) Pub. Date: Jan. 22, 2026

(54) SYSTEMS AND METHODS FOR GENERATING REPLIES TO MEMBER COMMENTS USING ARTIFICIAL INTELLIGENCE

(71) Applicant: Google LLC, Mountain View, CA (US)

(72) Inventors: Dhruv Bakshi, Zug (CH); Silviu Bota, Horgen (CH)

(21) Appl. No.: 18/779,888

(22) Filed: Jul. 22, 2024

(51) Int. Cl. H04N 21/4788; H04N 21/2187

(52) U.S. Cl. CPC H04N 21/4788; H04N 21/2187

(57) ABSTRACT

A method includes identifying, by a processing device of a content sharing platform, a comment associated with a media item on the content sharing platform. A prompt is provided as input to an artificial intelligence (AI) model to cause the AI model to generate a reply to the comment. An output of the artificial intelligence (AI) model is received. Based on the output, a reply window is pre-filled with a reply associated with the comment.

### TECHNICAL FIELD

The disclosed implementations relate to methods and systems for generating replies to member comments using artificial intelligence.

### BACKGROUND

Content sharing platforms allow users to connect to and share information with each other. Many content sharing platforms include a content sharing aspect that allows users to upload, view, and share content, such as video items, image items, audio items, and so on. Other users of the content sharing platform can comment on the shared content, discover new content, locate updates, share content, and otherwise interact with the provided content. The shared content can include content from professional channel owners, e.g., movie clips, TV clips, and music video items, as well as content from amateur channel owners, e.g., video blogging and short original video items.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

An aspect of the disclosure provides a computer-implemented method which includes identifying, by a processing device of a content sharing platform, a comment associated with a media item on the content sharing platform. A prompt is provided as input to an artificial intelligence (AI) model to cause the AI model to generate a reply to the comment. An output of the artificial intelligence (AI) model is received. Based on the output, a reply window is pre-filled with a reply associated with the comment.

A further aspect of the disclosure provides a system comprising: a memory; and a processing device, coupled to the memory, the processing device to perform a method according to any aspect or implementation described herein.

A further aspect of the disclosure provides a non-transitory computer-readable medium comprising instructions that, responsive to execution by a processing device, cause the processing device to perform operations according to any aspect or implementation described herein.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example of system architecture, in accordance with implementations of the disclosure.

FIG. 2 is an example graphical user interface (GUI) showing an example reply recommendation, in accordance with implementations of the disclosure.

FIG. 3 depicts a flow diagram of an example method for generating a reply recommendation, in accordance with implementations of the disclosure.

FIG. 4 depicts a block diagram of an example computing device operating in accordance with one or more aspects of the present disclosure.

### DETAILED DESCRIPTION

The content served by content sharing platforms can include video content, image content, audio content, text content, and so on (which may be collectively referred to as “media items”). Such media items can include audio clips, movie clips, TV clips, and music videos, as well as amateur content such as video blogging, short original videos, pictures, photos, other multimedia content, etc. In some content sharing platforms, channel owners can provide their content to other users via one or more personal channels (“channel”). A channel can be data content available from a common source or data content having a common topic, theme, or substance. The channel can be associated with a homepage for the channel owner's account and include media items having a common topic, theme, or substance. The media items can be chosen, made available, and/or uploaded by the channel owner to the channel. The channel owner can further customize their channel(s) by selecting a background and color scheme, controlling some of the information that visually represent the channel, etc.

Channel owners can enable certain content-related features to monetize their channel(s). For example, content creators can realize earnings from advertisements (“ads”) that would appear during certain segments of certain media items, receive revenue from viewers via a gratuity feature, sell merchandise, etc. In some instances, channel owners can generate revenue by enabling channel memberships that offer viewers (e.g., users of the content sharing platform) one or more particular tiers of content access (referred to as a “membership tier”). A membership tier is a feature of the content sharing platform that allows “members” to join a channel through monthly fees and receive members-only benefits also referred to as privileges. Each membership tier can have different privileges such as access to exclusive content (content not made available to non-members), badges, emojis, access to live-streams, chats and other bonus content that only members can access. In some instances, a particular channel can include multiple membership tiers, where each level can include different privileges for a different monthly fee.

In some systems, a members-only benefit can include comments by members receiving preferential status, such as, for example, being displayed in a members-only comment section. This is because receiving replies from channel owners can be one of the benefits to being a channel member. Channel owners typically reply to member comments to increase member contentment, thereby increasing member retention rates. However, for certain channel owners, replying to a copious amount of member comments can be a time-consuming task, where failure to timely and adequately respond to member comments can lead to loss of the respective members, thus causing the channel owners and the content sharing platform to miss out on potential revenue. Further, during live-stream sessions, a channel owner can receive an overwhelming amount of member comments in a live chat user interface to which the channel owner would be unable to adequately response. To provide answers to certain comments, either posted to a video or to a live-stream, the channel owner may need to search through previous responses and/or identify related videos or specific timestamps in those videos. This can cause the channel owner to waste considerable time and computing resources.

Aspects and implementations of the present disclosure address the above and other deficiencies by providing a system for generating replies to member comments using artificial intelligence. In particular, member comments can be displayed on a graphical user interface (GUI) of a channel owner's channel. In response to detecting that the channel owner selected the reply button with respect to a particular member comment, the system can automatically pre-fill the reply window with a suggested reply that is contextual to the comment. The suggested reply can be structured using a writing style related to the channel owner and can include, for example, a gratuity statement (e.g., thank you for your comment), answers to specific questions in the comment, references to a media item or a particular time stamp of the media item that is relevant to the member comment, etc. The channel owner can then post the suggested reply as generated or edit the suggested reply prior to posting.

In some implementations, the system of the present disclosure can use one or more artificial intelligence models, such as a large language model (LLM) to generate reply recommendations for member comments. A LLM is designed to understand and generate human-like text by analyzing and processing vast datasets of language from books, articles, and the internet. In some implementations, a foundational LLM can first be trained on data (e.g., comments, replies, etc.) from many different users of a content sharing platform. As such, the foundational LLM can be used as a baseline LLM model trained to understand how users draft replies to comments. Using the foundational LLM as a base, a respective personalized LLM can then be trained for certain channel owners. Each personalized LLM can be trained (e.g., fine-tuned) on data (e.g., past comments, replies, etc.) related to a particular channel owner. As such, each personalized LLM can be a specific LLM model trained to understand how a particular channel owner drafts replies to comments posted on their channel(s) (e.g., how the channel owner types, the channel owner's writing or commenting style, how the channel owner uses features such as emojis, etc.).

To generate a reply recommendation, the present system can generate an input prompt for a personalized LLM. The input prompt can contain instructions for the LLM and serve to guide the output of the LLM. In particular, the input prompt can include the member comment and the task assigned to the LLM (e.g., reply to the comment). The present system can then instruct the LLM to complete the assigned task and generate output data reflecting the results. Using the output data obtained from the LLM, the present system can automatically pre-fill the reply window of the member comment. By aiding the channel owner in responding to member comments, both the channel owners and the content sharing platform can earn additional revenue from retained members.

Aspects of the present disclosure result in improved performance of recommendation tools. In particular, the aspects of the present disclosure enable generating specific reply recommendations to the comments of members. As a result, the channel owner is able to conserve time when responding to member comments, and/or respond to more member comments during a time frame. By responding to the comments, members are content and membership retention is improved, and considerable time and computing resources are saved rather than being aimlessly expended by manually preparing responses.

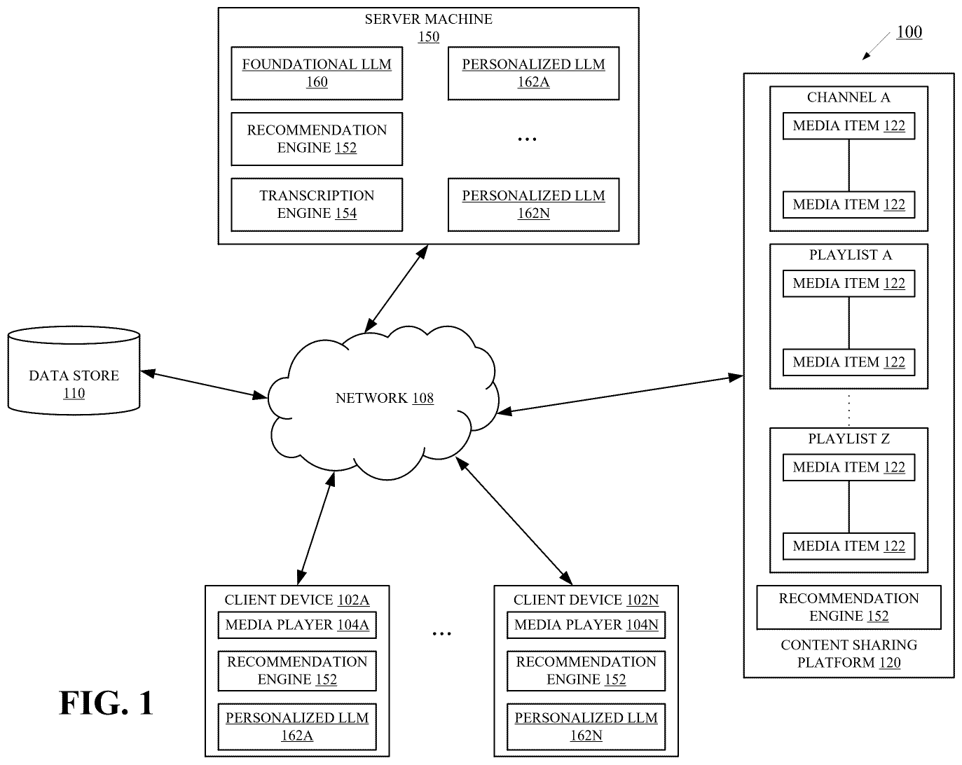

FIG. 1 illustrates an example system architecture 100, in accordance with implementations of the present disclosure. The system architecture 100 (also referred to as “system” herein) includes client devices 102A-102N, data store 110, content sharing platform 120, and/or server machine 150 each connected to a network 108. In some implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. Data store 110 can be hosted by one or more storage devices, such as main memory, magnetic or optical storage-based disks, tapes or hard drives, NAS, SAN, and so forth. In some implementations, data store 110 can be a network-attached file server, while in other implementations data store 110 can be some other type of persistent storage such as an object-oriented database, a relational database, and so forth, that may be hosted by application server 120 or one or more different machines (e.g., server machine 150, client device 102A-102N) coupled to the platform 120 via network 108.

Client devices 102A-102N can each include computing devices such as personal computers (PCs), laptops, mobile phones, smart phones, tablet computers, netbook computers, network-connected televisions, etc. In some implementations, client devices 102A-102N can also be referred to as “user devices.” In some implementations, each client device 102A-102N can include a media player 104A-104N, recommendation engine 152, personalized LLM 162A-162N, and/or transcription engine 154 (not shown). In some implementations, media player 104A-104N can be applications that allow users, such as channel owners, viewers, etc. to play back, view, or upload content, such as images, video items, web pages, documents, audio items, etc. For example, media players 104A-104N can be a web browser that can access, retrieve, present, or navigate content (e.g., web pages such as Hyper Text Markup Language (HTML) pages, digital media items, etc.) served by a web server. Media player 104A-104N can render, display, or present the content (e.g., a web page, a media viewer) to a user. In some implementations, media player 104A-104N can provide a user interface for presenting the media items and/or enabling user interaction with the media player 104A-104N. Media player 104A-104N can also include an embedded media player (e.g., a Flash® player or an HTML5 player) that is embedded in a web page (e.g., a web page that can provide information about a product sold by an online merchant). In another example, media players 104A-104N can be a standalone application (e.g., a mobile application, or native application) that allows users to playback digital media items (e.g., digital video items, digital images, electronic books, etc.). According to aspects of the present disclosure, media players 104A-104N can be a content sharing platform application for users to record, edit, and/or upload content for sharing on the content sharing platform. As such, media players 104A-104N can be provided to client devices 102A-102N by content sharing platform 120. For example, media players 104A-104N can be embedded media players that are embedded in web pages provided by the content sharing platform 120. In another example, media players 104A-104N can be applications that are downloaded from content sharing platform 120.

In some implementations, content sharing platform 120 and server machine 150, can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that can be used to provide a user with access to media items or provide the media items to the user. Content sharing platform 120 can allow a user to consume, upload, search for, approve of (“like”), disapprove of (“dislike”), or comment on media items. Content sharing platform 120 can also include a website (e.g., a webpage) or application back-end software that can be used to provide a user with access to the media items.

In some implementations of the disclosure, a “user” can be represented as a single individual. However, other implementations of the disclosure encompass a “user” being an entity controlled by a set of users and/or an automated source. For example, a set of individual users federated as a community in a social network can be considered a “user”. In another example, an automated consumer can be an automated ingestion pipeline, such as a topic channel, of the content sharing platform 120. In some implementations, the user can access content on sharing platform 120 through a user account. The user can access (e.g., log in to) the user account by providing user account information (e.g., username and password) via an application on client device 110 (e.g., media player 104A-104N). In some implementations, the user account can be associated with a single user. In other implementations, the user account can be a shared account (e.g., family account shared by multiple users) (also referred to as “shared user account” herein). The shared account can have multiple user profiles, each associated with a different user. The multiple users can login to the shared account using the same account information or different account information. In some implementations, the multiple users of the shared account can be differentiated based on the different user profiles of the shared account.

In some implementations, an authorizing data service (also referred to as a “core data service” or “authorizing data source” herein) is a secure service that has access to data pertaining to user accounts on the content sharing platform 120 and that can use this data to decide whether to authorize a user account to obtain a requested content. In some implementations, the authorizing data service can authorize a user account (e.g., a client device associated with the user account) to access the requested content, authorize delivery of the requested content to the client device, or both. Authorization of the delivery of the content can involve authorizing how the content is delivered. In some implementations, the authorizing data service can use user account information to authorize the user account. In some implementations, an authentication token associated with client device 102A-102N or media player 104A-104N can be used to determine whether to authorize the user account and/or playback of requested content. In some implementations, the authorizing data service is part of content sharing platform 120. In other implementations, the authorizing data service can be an external service, such as a highly-secured authorizing service offered by a third-party.

In some implementations, content delivery platform 120 can use a content distribution network (CDN) (not shown) to stream the media items to one or more client devices 102A-102N for consumption by users. A CDN includes a geographically distributed network of servers that work together to provide fast delivery of content. The network of the servers can be geographically distributed to provide high availability and high performance by distributing content or services based, in some instances, on proximity to client devices 102A-102N. The closer a CDN server is to a client device 102A-102N, the faster the content can be delivered to the client device 102A-102N.

A media item can include an electronic file that can be executed or loaded using software, firmware or hardware configured to present the media item to a user. A media item 122 can include, and is not limited to, digital video, digital movies, digital photos, digital music, audio content, melodies, website content, social media updates, electronic books (ebooks), electronic magazines, digital newspapers, digital audio books, electronic journals, web blogs, real simple syndication (RSS) feeds, electronic comic books, software applications, etc. In some implementations, the media item 122 can be a live-stream media item. In some implementations, content sharing platform 120 can store the media items 122 using the data store 106, or can the media items (or and identifier of the media item) as electronic files in one or more formats using data store 106.

A video item is used as an example of a media item 122 throughout this disclosure. A video item is a set of sequential image frames representing a scene in motion. For example, a series of sequential image frames can be captured continuously or later reconstructed to produce animation. Video items can be presented in various formats including, but not limited to, analog, digital, two-dimensional and three-dimensional video. Further, video items can include movies, video clips or any set of animated images to be displayed in sequence. In addition, a video item (or media item) can be stored as a video file that includes a video component and an audio component. The video component can refer to video data in a video coding format or image coding format (e.g., H.264 (MPEG-4 AVC), H.264 MPEG-4 Part 2, Graphic Interchange Format (GIF), WebP, etc.). The audio component can refer to audio data in an audio coding format (e.g., advanced audio coding (AAC), MP3, etc.). It can be noted GIF can be saved as an image file (e.g., .gif file) or saved as a series of images into an animated GIF (e.g., GIF89a format). It can be noted that H.264 can be a video coding format that is a block-oriented motion-compensation-based video compression standard for recording, compression, or distribution of video content, for example.

In some implementations, the media item can be streamed, such as in a live-stream, to one or more of client devices 102A-102Z. It is be noted that “streamed” or “streaming” refers to a transmission or broadcast of content, such as a media item, where the received portions of the media item can be played back by a receiving device immediately upon receipt (within technological limitations) or while other portions of the media content are being delivered, and without the entire media item having been received by the receiving device. “Stream” can refer to content, such as a media item, that is streamed or streaming. A live-stream media item can refer to a live broadcast or transmission of a live event, where the media item is concurrently transmitted, at least in part, as the event occurs to a receiving device, and where the media item is not available in its entirety.

In some implementations, content sharing platform 120 can allow users to create, share, view or use playlists containing media items (e.g., playlist A-Z, containing media items 122). A playlist refers to a collection of media items that are configured to play one after another in a particular order without any user interaction. In some implementations, content sharing platform 120 can maintain the playlist on behalf of a user. In some implementations, the playlist feature of the content sharing platform 120 allows users to group their favorite media items together in a single location for playback. In some implementations, content sharing platform 120 can send a media item on a playlist to client device 102A-102N for playback or display. For example, media player 104A-104N can be used to play the media items on a playlist in the order in which the media items are listed on the playlist. In another example, a user can transition between media items on a playlist. In yet another example, a user can wait for the next media item on the playlist to play or can select a particular media item in the playlist for playback.

The content sharing platform 120 can include multiple channels (e.g., channels A through Z, of which only channel A is shown in FIG. 1) for providing media items from a common source or having a common topic, theme, or substance. Each channel can include one or more media items and can be managed by an owner (referred to as a “channel owner”), who is a user that can perform administrative actions on the channel. The administrative actions can include making media items available on the channel (e.g., choosing, uploading, and/or allowing presentation of the media items), enabling advertisements for the media items, enabling one or more membership tiers on the channel, etc. For example, a channel X (not shown) can include video media items Y and Z that were uploaded by the channel owner.

In some implementations, the channel owner can enable channel memberships that provide one or more membership tiers on a channel. Each membership tier can allow “members” to join the channel through monthly fees and receive privileges (e.g., members-only benefits) that can include access to exclusive content, badges, emojis, access to live-streams, chats, etc. In some implementations, a particular channel can offer multiple membership tiers, where each level can include different privileges for a different monthly fee.

In some implementations, content sharing platform 120 (and/or server machine 150 and/or client device 102A-102N) can include recommendation engine 152 that can generate recommendations to one or more channel owners of content sharing platform 120. In some implementations, a recommendation can include an auto-generated message that provides a channel owner with a personalized reply (referred to as a “reply recommendation”) to a particular comment from a member (or from a viewer). In some implementations, the recommendation(s) can be presented on media player 104A-104N (e.g., on the user interface associated with a channel of a channel owner) and/or provided to the channel owner using other means.

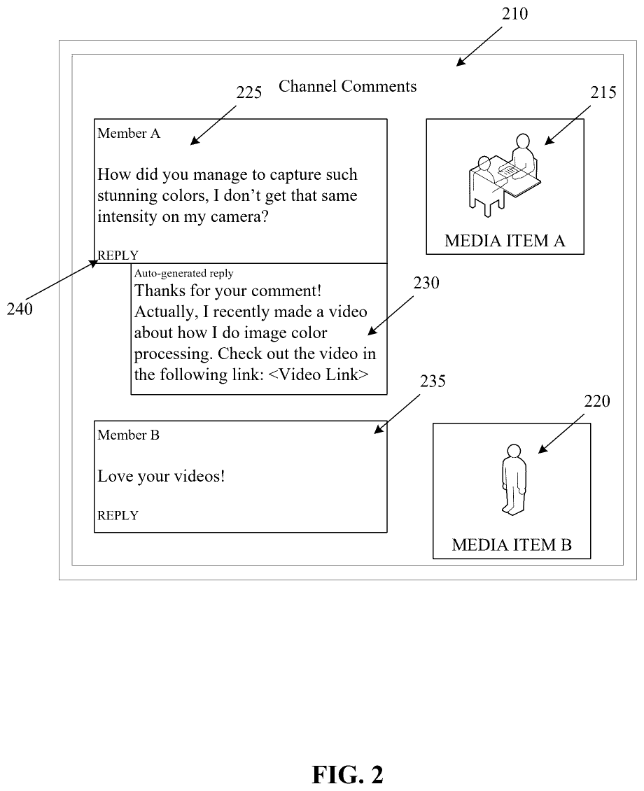

FIG. 2 is an example graphical user interface (GUI) showing an example reply recommendation, in accordance with implementations of the present disclosure. In particular, FIG. 2 shows GUI 210 which presents a channel comment section of a channel owner's channel (e.g., channel A). The channel comments section includes two comments 225, 235. Comment A 225 is made by member A in relation to media item A 215 and comment B 235 is made by member B in relation to media item B 220. In response to the channel owner selecting reply button 240, a reply interface is displayed with an auto-generated reply recommendation 230. The reply recommendation 230 can be generated by recommendation engine 152. As shown, the reply recommendation is personalized to member A's comment. In particular, member A asks the channel owner “How did you manage to capture such stunning colors, I don't get that same intensity on my camara?” Reply recommendation 230 states: “Thanks for your comment! Actually, I recently made a video about how I do image color processing. Chack out the video in the following link: <Video Link>.” The auto-generated reply can then be posted by the content creator as generated or edited by the channel owner prior to posting.

Returning to FIG. 1, in some implementations, the recommendations can be generated using data obtained from foundational LLM 160 and/or personalized LLM 162. An LLM is a type of artificial intelligence (e.g., machine learning) model designed to understand and generate human-like text. In particular, LLM 160, 162 can perform natural language processing tasks such as language translation, text summarization, question answering, etc. LLM 160, 162 can be built on deep learning architectures, such as transformer models. In some implementations, LLM 160, 162 can be generated through supervised learning, during which LLM 160, 162 is trained on large datasets of text. The text can be gathered from various sources, such as books, articles, websites, content sharing platform comments, speech to text data, etc.

In some implementations, a text dataset can be used to pre-train LLM 160, 162 on a language modeling task where LLM 160, 162 learns to predict the next word in a sequence of text given the previous words. This pre-training phase can be used to develop, for LLM 160, 162, a deep understanding of language patterns and semantics. After pre-training, LLM 160, 162 can be fine-tuned on specific tasks to specialize its capabilities. During fine-tuning, LLM 160, 162 can be exposed to examples of the target task, such as text classification or language translation, corresponding labels or target outputs, etc. In some implementations, LLM 160, 162 can adjust one or more parameters to minimize the difference between predictions and true outputs. The adjusting can be performed using iterative optimization techniques, such as, for example, gradient descent. The adjusting process can enable LLM 160, 162 to adapt pre-learned knowledge to the nuances of the target task, making it more effective in real-world applications. In some implementations, LLM 160, 162 can be used to generate replies to member comments. This will be described in detail below.

In some implementations, foundational LLM 160 can be pre-trained and/or fine-tuned on data (e.g., comments, replies, etc.) from many different users, such as, for example, channel owners, viewers, members, etc. As such, foundational LLM 160 can be a baseline LLM model trained to understand how users draft replies to comments. In some implementations, multiple foundational LLMs can be trained based on groups of users having certain characteristics or of a certain location. For example, each foundational LLM can be pre-trained and/or fine-tuned based on a set of regional users (e.g., country, state, providence, etc.) and/or a set of users with specific characteristics (e.g., age brackets, gender, race, language, interests, etc.). In some implementations, foundational LLM 160 can be periodically retrained (e.g., refined) using new data, such as, for example, new comments and replies posted by users.

In some implementations, personalized LLM 162 can be a foundation LLM 160 that is further trained (e.g., pre-trained and/or fine-tuned) on data (e.g., past comments, replies, etc.) of a particular channel owner. As such, personalized LLM 162 can be a specific LLM model trained to understand how a particular channel owner drafts replies to comments posted on their channel(s) (e.g., how the channel owner types, the channel owner's writing or commenting style, how the channel owner uses additional features such as emojis, etc.). In some implementations, each personalized LLM can be stored on server machine 150, content sharing platform 120, client device 102A-102N, or any combination thereof. By way of illustrative example, each personalized LLM 162 can be stored on each respective channel owner's client device 102A-102N.

In some implementations, personalized LLM 162 can be trained on one or more media items (e.g., videos) related to a channel owner. By training personalized LLM 162 on the channel owner's media items, personalized LLM 162 can, in a reply recommendation, identify a media item that is relevant to a comment or a particular point in a media item that is relevant to a comment. For example, if a member posts a comment with a question, and the question is answered in a video on the channel owner's channel, then personalized LLM 162 can include a reference to the video, a link to the video, a timestamp related to the answer in the video, etc.

In some implementations, personalized LLM 162 can be trained on one or more media items not related to (e.g., not posted by) the channel owner. Similarly, by training personalized LLM 162 on other media items, personalized LLM 162 can, in a reply recommendation, identify a particular point in a media item that is relevant to a comment posted on the channel owner's channel. In an example, the other media items can be related to the content of the channel owner's channel (e.g., based on the same or a similar subject matter).

In some implementations, personalized LLM 162 can be retrained using the output generated by personalized LLM 162 and/or the modifications (e.g., edits) made to the output by the channel owner. In particular, once personalized LLM 162 generates an output (e.g., a reply recommendation), the channel owner can post the reply as recommended, or make one or more edits to the reply recommendation prior to posting. The posted reply can then be used to further fine-tune personalized LLM 162. This retraining can be performed in response to each posted reply, in response to a threshold number of replies posted, periodically, etc.

In some implementations, in order to generate reply recommendations, recommendation engine 152 can use, as input for personalized LLM 162, data relating to one or more comments posted to the channel owner's channel and/or data related to one or more media items (e.g., videos) posted on the channel owner's channel.

In some implementations, the date related to one or more media items posted on the channel owner's channel can relate to one or more audio related features (e.g., audio transcription data). Audio transcription data can include a transcription of the audio data from a segment of a media item (e.g., from a video) or from the entirety of the media item. In some implementations, transcription engine 154 can generate the audio transcription data using a text extractor system (e.g., software, an algorithm, etc.). For example, transcription engine 154 can convert audio data corresponding to a media item (or corresponding to one or more segments of the media item) into text data. Examples of the text extractor system can include a text-embedding model (e.g., the universal sentence embedding model), a speech recognition model, a speech-to-text model, etc. In some implementations, the audio transcription data can be generated by user input. For example, a user (e.g., a channel owner) can generate a transcript of the audio corresponding to one or more segments of a media item and/or to one or more media items. The transcript can be included, for example, as metadata related to the media item. In some implementations, the audio transcription data can be generated using an optical character recognition (OCR) system. An OCR system can include a software tool that converts visual data (e.g., images, frames, etc.) into editable and searchable text. In one example, an OCR system can generate text data from closed captions or subtitles associated with a media item 122 (e.g., if such closed captions or subtitles associated with the media item 122 are not otherwise available).

Recommendation engine 152 can instruct LLM 160, 162 to perform one or more tasks. A task can refer to the type of data or analysis desired from LLM 160, 162. The tasks can include, for example, generating a reply recommendation, generating a reference of link to a media item, using a particular format for generating output data, etc.

The output format can reflect how the LLM 160, 162 is to provide the data it was tasked to obtain. In some implementations, the output format can instruct LLM 160, 162 to generate a basic response for statements (e.g., “this video is awesome”), such as, for example, “thank you for your comment,” “I appreciate you watching my video,” etc. In some implementations, the output format can instruct LLM 160, 162 to generate an answer for each question identified in a comment. In some implementations, the output format can instruct the LLM to provide timestamp data related to a relevant segment (if found) identified in a media item on the channel, or outside the channel.

Recommendation engine 152 can then obtain, as output from LLM 160, 162, data reflecting the reply recommendation. Recommendation engine 152 can then supply the text data reflecting the reply recommendation in the reply prompt of the member comment. This allows the channel owner to post the reply or edit the reply prior to posting.

In some implementations, personalized LLM 162 can be retrained (and/or fine-tuned) using the edits a channel owner applies to a reply recommendation. For example, the reply recommendation generated by personalized LLM 162 and the corresponding reply posted by the content creator can both be used to retrain personalized LLM 162. This enables personalized LLM 162 to generate reply recommendations that are more consistent with the types of replies the channel owner may draft.

In some implementations, a media item can be a live-streamed media item. The live-streamed media item can include a chat user interface (e.g., a chat window) where users (e.g., members) can post comments during the live-stream. During such implementations, recommendation engine 152 can generate reply recommendations during the live-stream by instructing LLM 162 to generate output data based on a predetermined output format. The reply recommendation can be generated automatically in response to every comment posted, in response to the content creator selecting a “reply” button related to a comment, etc. This allows the channel owner to quickly respond to comments during the livestream.

In some implementations, other AI models can be used in place or in addition to LLM 160, 162, such as deep networks. An example of a deep network is a neural network with one or more hidden layers, and such an AI model can be trained by, for example, adjusting weights of a neural network in accordance with a backpropagation learning algorithm or the like. In other or similar implementations, the AI model can be created by finding patterns in training data, identifying clusters of data that correspond to the identified patterns, and providing the AI models that capture these patterns. Some AI models can use one or more of support vector machine (SVM), Radial Basis Function (RBF), clustering, supervised machine learning, semi-supervised machine learning, unsupervised machine learning, k-nearest neighbor algorithm (k-NN), linear regression, multi-linear regression, non-linear regression, random forest, gradient-boosted trees, neural network (e.g., artificial neural network), etc.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

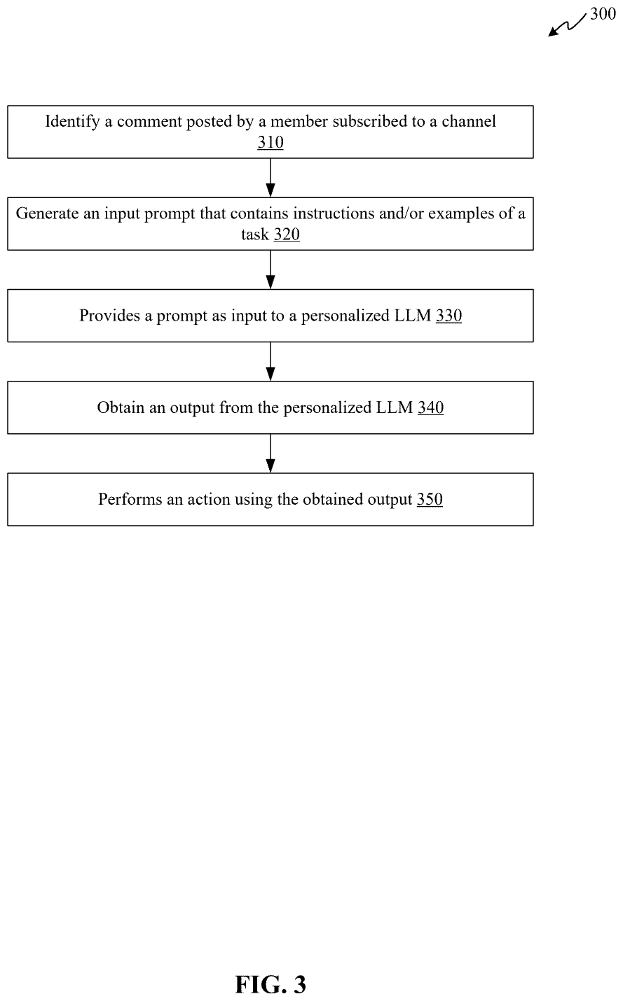

FIG. 3 depicts a flow diagram of an example method 300 for generating a reply recommendation, in accordance with implementations of the present disclosure. Method 300 can be performed by processing logic that can include hardware (circuitry, dedicated logic, etc.), software (e.g., instructions run on a processing device), or a combination thereof. In one implementation, some or all of the operations of method 300 can be performed by one or more components of system 100 of FIG. 1. In some implementations, some or all of the operations of method 300 can be performed by recommendation engine 152, as described above.

For simplicity of explanation, method 300, as well as any other method of this disclosure, is depicted and described as a series of acts. However, acts in accordance with this disclosure can occur in various orders and/or concurrently, and with other acts not presented and described herein. Furthermore, not all illustrated acts may be required to implement method 300 in accordance with the disclosed subject matter. In addition, those skilled in the art will understand and appreciate that method 300 could alternatively be represented as a series of interrelated states via a state diagram or events. Additionally, it should be appreciated that method 400 disclosed in this specification is capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At operation 310, processing logic identifies a comment posted by a member subscribed to a channel. In some implementations, the comment can be identified in response to a channel owner selecting a corresponding reply button. In some implementations, the comment can be identified in response to the member posting the comment. In some implementations, the comment can be identified during a background operation performed by the content sharing platform and/or media player (e.g., the content sharing platform periodically scans a channel and identifies member comments that do not have a reply posted). In some implementations, the comment can be from a non-member (e.g., a user without a subscription to the channel).

At operation 320, processing logic generates an input prompt that contains instructions and/or examples of a task. The input prompt can serve to guide the output of personalized LLM 162.

In some implementations, the input prompt can include content instructions. Content instructions can be used to inform an LLM (e.g., personalized LLM 162) about the type of conversation personalized LLM 162 is engaging in and/or the function personalized LLM 162 is to perform. The context instructions can be used to aid personalized LLM 162 in avoiding lengthy replies, consistently generating readable text, expediting operations, etc. In an illustrative example, context instruction can include the following prompt:
Channel members can comment on or ask questions in relation to videos on a channel of a content sharing platform. Channel owners can reply to those comments with gratuity statements and/or answers to the questions.

In some implementations, the input prompt can include task instructions. Task instructions can be used to identify the type of data or analysis desired from personalized LLM 162. In an illustrative example, task instructions can include the following prompt:
Carefully consider the comment text below and generate an appropriate reply to the comment. If the comment includes one or more questions, craft an appropriate answer to the question. If a video on the channel can be helpful in answering the questions, include a corresponding statement and link to a timestamp in the video.

In some implementations, the input prompt can include one or more examples. The examples can provide additional context to personalized LLM 162, such as, for example, how personalized LLM 162 should answer. In particular, the examples can illustrate to personalized LLM 162 the type of data desired, the type of format desired, how to format a reply with a link to a video, etc.

In some implementations, the input prompt can include data related to the media item on which the member comment is posted and/or data related to other media items on the channel owner's channel. The data related to the media item can be audio transcription data that includes a transcription of the audio data from a segment of a media item or from the entirety of the media item. In some implementations, the processing logic can obtain the audio transcription data using, for example, a text extractor system (e.g., a text-embedding model, a speech recognition model, a speech-to-text model, etc.). In some implementations, the processing logic can generate the audio transcription data from closed captions or subtitles associated with a media item. Alternatively, the data related to the media item can be the media item itself. In other implementations, personalized LLM 162 can be pre-trained and/or fine-tuned on the media items posted on the channel (and/or other media items). As such, the input prompt may not include data related to the media item on which the member comment is posted and/or data related to other media items on the channel owner's channel.

At operation 330, processing logic provides a prompt as input to personalized LLM 162. For example, processing logic provides the input prompt including content described above and instructions to personalized LLM 162 to perform the requested task.

At operation 340, processing logic obtains an output from personalized LLM 162. The output can reflect the results generated by personalized LLM 162 from performing the requested task. In some implementations, the output can be in the format that personalized LLM 162 was requested to use.

At operation 350, processing logic performs an action using the obtained output. In some implementations, such as those where the output is generated in response to channel owner selecting the reply button, the processing logic can pre-fill, based on the obtained output, the input field of the reply window related to the member comment. In some implementations, such as those where the output is generated in response to the member posting the comment or a background operation being performed, the processing logic can store the obtained output and pre-fill the reply window once the channel owner selects the reply button. In some implementations, the posted reply can be used to retrain the personalized LLM 162.

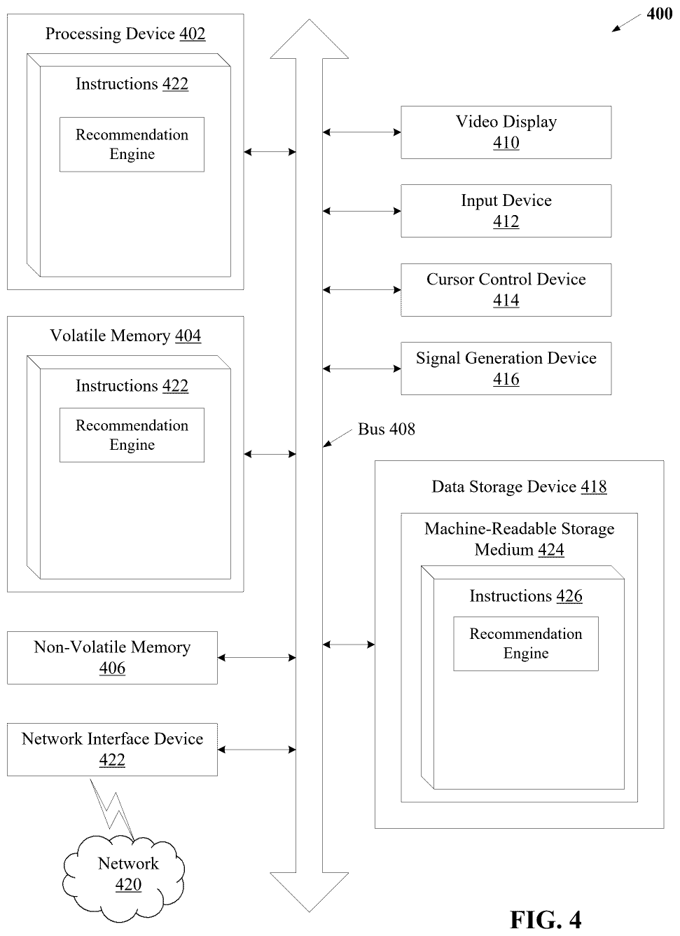

FIG. 4 depicts a block diagram of a computer system operating in accordance with one or more aspects of the present disclosure. In certain implementations, computer system 400 can be connected (e.g., via a network, such as a Local Area Network (LAN), an intranet, an extranet, or the Internet) to other computer systems. Computer system 400 can operate in the capacity of a client device. Computer system 400 can operate in the capacity of a server or a client computer in a client-server environment. Computer system 400 can be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 400 can include a processing device 402, a volatile memory 404 (e.g., random access memory (RAM)), a non-volatile memory 406 (e.g., read-only memory (ROM) or electrically erasable programmable ROM (EEPROM)), and a data storage device 418, which can communicate with each other via a bus 408.

Processing device 402 can be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 400 can further include a network interface device 422. Computer system 400 also can include a video display unit 410 (e.g., an LCD), an input device 412 (e.g., a keyboard, an alphanumeric keyboard, a motion sensing input device, touch screen), a cursor control device 414 (e.g., a mouse), and a signal generation device 416.

Data storage device 418 can include a non-transitory machine-readable storage medium 424 on which can store instructions 426 encoding any one or more of the methods or functions described herein, including instructions encoding components of client device of FIG. 1 for implementing method 300.

Instructions 426 can also reside, completely or partially, within volatile memory 404 and/or within processing device 402 during execution thereof by computer system 400, hence, volatile memory 404 and processing device 402 can also constitute machine-readable storage media.

While machine-readable storage medium 424 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as ASICS, FPGAs, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “receiving,” “determining,” “sending,” “displaying,” “identifying,” “selecting,” “excluding,” “creating,” “adding,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and cannot have an ordinal meaning according to their numerical designation.

Examples described herein also relate to an apparatus for performing the methods described herein. This apparatus can be specially constructed for performing the methods described herein, or it can comprise a general-purpose computer system selectively programmed by a computer program stored in the computer system. Such a computer program can be stored in a computer-readable tangible storage medium.

The methods and illustrative examples described herein are not inherently related to any particular computer or other apparatus. Various general-purpose systems can be used in accordance with the teachings described herein, or it can prove convenient to construct more specialized apparatus to perform method 400 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
receiving, by a processing device of a content sharing platform, an indication of a selection of a user interface (UI) element associated with a comment posted, by a user, to a media item on the content sharing platform;
generating a reply window for the comment;
providing, as input to an artificial intelligence (AI) model, a prompt to cause the AI model to generate a reply to the comment;
receiving an output of the artificial intelligence (AI) model; and
pre-filling, based on the output, a reply window with a reply associated with the comment.

2. The method of claim 1, wherein the output comprises a link to a certain timestamp associated with the media item.

3. The method of claim 1, further comprising:
retraining the AI model based on the reply.

4. The method of claim 3, wherein the reply comprises one or more edits of a channel owner associated with the media item.

5. The method of claim 1, wherein the comment is identified in response to a channel owner associated with the media item selecting a button associated with the comment.

6. The method of claim 1, wherein the comment is identified in response to a user posting the comment.

7. The method of claim 1, wherein the media item is a live stream, and the comment is identified in response to a user joining the live stream or in response to a user posting a message in a chat associated with the live stream.

8. The method of claim 1, wherein the AI model is trained using a plurality of media items posted on a channel associated with the media item.

9. A system comprising:
a memory; and
a processing device, coupled to the memory, the processing device to perform operations comprising:
receiving an indication of a selection of a user interface (UI) element associated with a comment posted, by a user, to a media item on a content sharing platform;
generating a reply window for the comment;
providing, as input to an artificial intelligence (AI) model, a prompt to cause the AI model to generate a reply to the comment;
receiving an output of the artificial intelligence (AI) model; and
pre-filling, based on the output, a reply window with a reply associated with the comment.

10. The system of claim 9, wherein the output comprises a link to a certain timestamp associated with the media item.

11. The system of claim 9, wherein the operations further comprise:
retraining the AI model based on the reply.

12. The system of claim 11, wherein the reply comprises one or more edits of a channel owner associated with the media item.

13. The system of claim 9, wherein the comment is identified in response to a channel owner associated with the media item selecting a button associated with the comment.

14. The system of claim 9, wherein the comment is identified in response to a user posting the comment.

15. The system of claim 9, wherein the media item is a live stream, and the comment is identified in response to a user joining the live stream or in response to a user posting a message in a chat associated with the live stream.

16. The system of claim 9, wherein the AI model is trained using a plurality of media items posted on a channel associated with the media item.

17. A non-transitory computer-readable medium comprising instructions that, responsive to execution by a processing device, cause the processing device to perform operations comprising:
receiving an indication of a selection of a user interface (UI) element associated with a comment posted, by a user, to a media item on a content sharing platform;
generating a reply window for the comment;
providing, as input to an artificial intelligence (AI) model, a prompt to cause the AI model to generate a reply to the comment;
receiving an output of the artificial intelligence (AI) model; and
pre-filling, based on the output, a reply window with a reply associated with the comment.

18. The non-transitory computer readable storage medium of claim 15, wherein the operations further comprise:
retraining the AI model based on the reply.

19. The non-transitory computer readable storage medium of claim 15, wherein the comment is identified in response to a channel owner associated with the media item selecting a button associated with the comment.

20. The non-transitory computer readable storage medium of claim 15, wherein the comment is identified in response to a user posting the comment.
